(19) United States
(12) Patent Application Publication
(10) Pub. No.: US 2019/0378430 A1
(43) Pub. Date: Dec. 12, 2019

(54) VISITOR CENTER AND METHOD FOR ENHANCING MUSIC APPRECIATION

(71) Applicant: Ruta Kleiman Keinan, Ramat Gan (IL)

(72) Inventor: Ruta Kleiman Keinan, Ramat Gan (IL)

(21) Appl. No.: 16/000,927

(22) Filed: Jun. 6, 2018

(51) Int. Cl. G09B 15/02; G10D 7/06; G10D 1/00; G10D 13/00

(52) U.S. Cl. CPC G09B 15/023; G10D 7/06; G10D 1/00; A63J 17/00; G10H 2220/096; G10H 2220/026; G10D 13/00

(57) ABSTRACT

A music visitor center comprising an interactive string instrument exhibition comprising at least one resonance chamber and at least one string that may be mounted to the at least one resonance chamber and excited to vibrate and generate an amplified musical sound, an interactive percussion instrument exhibition comprising at least one drum shell and at least one drumhead that may be mounted to the at least one drum shell and excited to vibrate and generate an amplified percussive sound, an interactive wind instrument exhibition comprising at least one air tube and at least one mouthpiece having a reed that may be mounted to the at least one air tube and excited to vibrate and generate an amplified wind instrument sound, and a path along which the exhibitions are located that constrains a visitor moving along the path to encounter in order, the string, percussion and wind instrument exhibitions.

### FIELD

Embodiments of the invention relate to a visitor center, interactive visitor center displays, and methods for enhancing music appreciation and enhancing an ability to listen.

### BACKGROUND

Many music teaching and learning methods are provided to help music students acquire control of, and skills in operating musical instruments, and gain understating of a musical notation system, so that a student may translate the musical notation presented in music sheets, into operation of a desired musical instrument. Various musical instruments are constructed for those purposes of learning to master a desired musical instrument. The music teaching and learning methods may be provided in various buildings and facilities constructed to house teaching rooms, musical instruments and optionally exhibitions related to music.

### SUMMARY

Embodiments of the invention relate to providing a visitor center comprising interactive displays and exhibits, musical instruments and apparatuses, hereinafter generically referred to as “interactive exhibits”, for enhancing one's ability to listen and discern elements of sound and music and for enhancing music and sound appreciation. In an embodiment t of the invention, the interactive exhibits enable a perception of sounds from sight and through tactile sensation, to full-body awareness. By way of example, sounds may be viewed as the motion of a string or felt by a hand placed on a vibrating drumhead, sensed by one's lips blowing through a wind instrument, and experienced by a whole body when close enough to a sound generator. An embodiment of the invention relates to internalizing concepts of complex sounds by enabling one to experience combinations of simpler sounds.

In an embodiment of the invention, the visitor center is spatially configured and programmed so that a visitor may walk through the visitor center along a “listening path”. The listening path presents the visitor with an ordered sequence of interactive exhibits with which the visitor interacts to acquire an understanding of various elements and concepts of sound and music. Optionally, the order of the interactive exhibits is provided so that each experience, after a first experience of an interactive exhibit, builds upon a previous experience of an interactive exhibit. As a visitor of the visitor center progresses from one experience to a next along the listening path, the visitor's ability to listen to sounds and music and resolve sound elements comprised in the music is developed, and the visitor's potential for understanding and enjoying sound and music, is enhanced.

In an embodiment of the invention, the listening path may implement a four stage method for interactively teaching and enhancing sound and music appreciation through sensualization of sound. Each stage is experienced in a separate region in which interactive exhibits associated with the stage are located. Each stage introduces and teaches through interaction with the interactive exhibits in the stage's region, concepts of sound and music that build upon concepts of sound and music experienced in a previous stage. The visitor center is designed so that regions associated with the listening path are sequentially encountered in a desired order when the visitor moves along the listening path.

By way of example, in a first stage, the visitor may operate various musical apparatuses in a desired ordered “series of tasks”, of generating sound, provided to enhance the visitor's perception of basic concepts of sound such as mechanisms by which sounds are produced. Optionally, tasks in the first stage provide the visitor sequentially with experiences of generating and amplifying sounds made by string, percussion, and wind instruments respectively. For example, the visitor performs tasks related to groups of instruments where he or she may visually observe a vibrating object such as a string, a drumhead. The visitor may than couple a resonance chamber to the vibrating object where he or she may hear a sound while observing the vibrating object. Optionally, the visitor may physically feel the vibration generated by the vibrating object in the palms of his or her hands such as a vibrating drumhead or sense the vibration in his or her mouth, such as the vibration of air in a wind column of a musical mouthpiece when blown through the mouthpiece. Optionally, and after the visitor has perceived generation of sound by musical instruments comprising a vibrating object as a source of sound, the visitor performs tasks related a computer-machine sound generator, such as synthesizer, where he or she experiences sounds produced digitally.

After completing the series of tasks in the first stage, the visitor may progress to a next stage in a next region along the listening path, where he or she operates a “musical wall”. The musical wall broadens the visitor's understanding of the “mechanics” of music, such as pitch and musical notation, musical scales, chords and melody, and complexity of musical composition. The musical wall comprises a plurality of actuators, optionally operated by buttons or touch pads located on the wall. Each button is associated with a particular frequency or pitch of a musical note and appears on a musical staff. The presentation of the button on a musical staff allows visualizing a note's frequency in relation to its position on the staff.

At a next region of a third stage along the listening path, the visitor approaches an interactive exhibit, an “Audio-Mixing Station” that the visitor may operate to alter, or “remix” various musical compositions belonging to various musical genres such as classic, jazz, pop, or rock, in accordance with an embodiment of the invention. The Audio Mixing Station allows the visitor to experience how sounds made by various musical instruments or musical sections add up to create the musical work.

At a fourth stage along the listening path, the visitor may freely walk on a stage that may have a live musical band such as an orchestra, or manikins controlled to play musical instruments, in accordance with an embodiment of the invention. The fourth stage provides a sensualizing experience of sound and music optionally provided throughout the listening path. The visitor moves among sources of components of a musical composition by freely allowing him or her to experience components of a music composition from different distances from instruments generating the components, and generate an intuition as to how the components meld with change in distance and direction of location of the visitor relative to the orchestra.

Following completion of the listening path, the visitor may proceed to remaining regions of the visitor center comprising interactive exhibits provided to enrich and enhance the visitor's musical experiences and listening experiences. By way of example, additional regions may present musical subject matters related to music as a function of religion and culture, music as a function of various art forms, music and entertainment, and a musical garden.

In the discussion unless otherwise stated, adjectives, such as “substantially” and “about”, modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to the figures attached hereto and noted following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically shows a visitor center having interactive exhibits arranged along a listening path, in accordance with an embodiment of the invention; FIG. 2A-FIG. 2C schematically show an interactive exhibit having modular components for illustrating sound generated by stringed instruments, in accordance with an embodiment of the invention;

FIG. 3A-FIG. 3C schematically show an interactive exhibit having drum skins and drum shells for illustrating sounds generated by percussion instruments, in accordance with an embodiment of the invention;

FIG. 4A schematically shows a mouthpiece comprised in an interactive exhibit for illustrating sounds generated by wind instruments, in accordance with an embodiment of the invention;

FIG. 4B schematically shows two air tubes, in accordance with an embodiment of the invention;

FIG. 5A-FIG. 5D schematically shows an interactive exhibit comprising a musical wall having a touch screen displaying various musical touch notes of a C major musical scale, of two melodies, counterpoint and canon, and chords, in accordance with an embodiment of the invention;

FIG. 6 schematically shows an Audio Mixing Station, in accordance with an embodiment of the invention;

FIG. 7 schematically shows a Jazz band on a stage, in accordance with an embodiment of the invention;

FIG. 8 schematically shows musical stairs, in accordance with an embodiment of the invention;

FIG. 9 schematically shows musical flower bed, in accordance with an embodiment of the invention;

### DETAILED DESCRIPTION

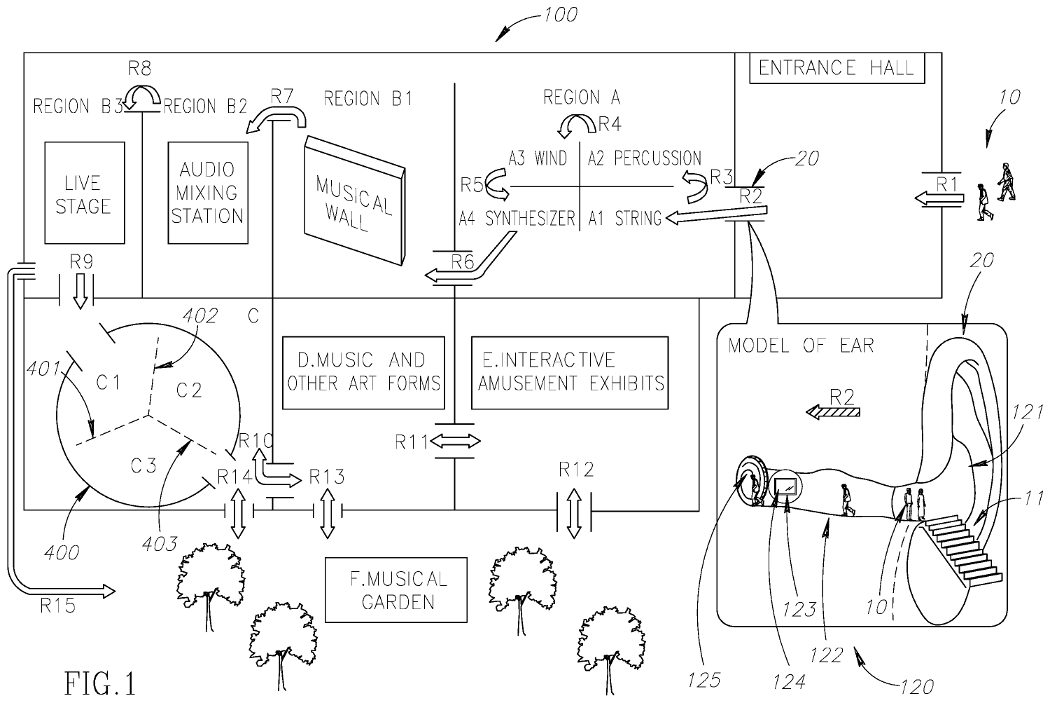

FIG. 1 schematically shows a visitor center layout 100, comprising optionally six regions labeled A, B, C, D, E and F respectively. Regions A and B implement a listening path dictating ordered progression through these regions. All regions may be divided into spaces, areas or rooms containing interactive exhibits to be described below. Additional spaces, areas or rooms containing additional interactive exhibits, may be configured in the visitor center and/or may be located between the additional spaces, such as in halls and corridors. Arrows R1, R2, R3 . . . Rn schematically define and show a direction of movement, of a visitor 10, through the music visitor center, as described below. FIG. 1 schematically shows visitor 10 entering an Entrance Hall of the visitor center in a direction indicated by a block arrow R1 where the listening path begins, in accordance with an embodiment of the invention.

The Entrance Hall comprises various interactive exhibits and configurations provided to insulate the visitor from the outside ambient environment and bring the visitor mentally and physically into a substantially isolated sound and music ambience, by captivating the visitor's attention, in accordance with an embodiment of the invention. By way of example, Entrance Hall may be configured with sound insulated chambers (not shown) so that music being played in a chamber isn't disrupted by other activities in the Entrance Hall. Music which is played in each chamber may be associated with an emotion, such as happiness, fear, sadness, and/or serenity. When visitor 10 enters a chamber he or she experiences the music and its associated emotion without being distracted by sounds from the outside environment.

Visitor 10 may exit Entrance Hall in a direction shown by a block arrow R2, to enter a greatly enlarged model 20 of an ear comprising models of internal features of the ear that are responsible for providing hearing and sensitivity to different frequencies of sound. A cutaway image of ear model 20 is schematically shown in an inset 120.

Ear model 20 may be sufficiently large so that a group of visitors of the visitor [connecting corridor] center may gather in and progress through model 20 as a group. The ear model, in accordance with an embodiment of the invention, comprises structural displays and exhibits corresponding to anatomical and physiological features of a human ear that provide functionalities of hearing and resolving sounds. By way of example, an opening 121 to ear display 20 is shaped as an auricle, a corridor is shaped as an outer ear canal 122. Visitor 10 walks through outer ear canal 122 until reaching an eardrum display 123. Eardrum display 123 comprises optionally a video screen 124 for showing an explanatory video and/or presentation on the acoustics of hearing and the auditory system. Optionally, the model of the ear comprises models of features, such as the ossicles and cochlea (not shown), on a far side of the ear drum from the outer ear canal. Optionally, the visitor may exit model 20 through an exit 125 in a hallway (not shown) that models a cochlea to enter a region A, a region of multiple sensualization of sound, as indicated by block arrow R2.

In an embodiment of the invention, region A is divided into four sensualization spaces labeled A1, A2, A3, and A4 indicated in FIG. 1. The sensualization spaces are associated with sensualization of sound associated with each of optionally four groups of musical apparatuses, as described below. The groups of apparatuses are indicated in FIG. 1, and include sensualization of sounds generated by: string instruments in sensualization space A1, percussion instruments in sensualization space A2, wind instruments in sensualization space A3 and optionally synthesizer in sensualization space A4.

In an embodiment of the invention, the visitor is constrained by the architecture of region A to progress from one sensualization space and its group of apparatuses for generating sound to a next sensualization space providing a next sensualization space and its groups of apparatuses of generating sound in a defined order, as indicated by block arrows R3-R5. As a result, the visitor is constrained to perform tasks for the apparatuses in each group, in order of the groups as they are encountered by the visitor progressing in the directions of block arrows R3-R5. In order to prevent interference between the sensualization spaces from use of the apparatuses, at any one time, only one sensualization space is occupied and/or only one apparatus of a group of apparatuses is operated. Optionally the sensualization spaces are acoustically sealed to prevent interference from use of the apparatuses, when more than one sensualization space is occupied and/or more than one apparatus operated, at the same time. The tasks are provided to educate the visitor through experiencing the generation of sounds by operating various sound generators and amplifiers. Optionally the series of tasks are substantially the same for each group of musical apparatuses.

Visitor 10 initially enters sensualization space A1 and performs tasks relating to string instruments in accordance with an embodiment of the invention, so that the visitor may visualize and/or hear sounds generated by vibrations of a string. FIG. 2A and FIG. 2B schematically show components of an interactive string exhibit, referred to as a modular string apparatus 30. Modular string apparatus 30 comprises a stretched string 31 attached and fixed at both its ends 35 and 36 to beams 33 (FIG. 2A). Beams 33 provide modular string apparatus 30 with support so it may stand on a floor (not shown). Optionally any other supporting structure for the modular string apparatus may replace beams 33. Dashed wave line 37, shows an example of a natural pattern of vibration of string 31, when string 31 is excited to vibrate. String 31 may be any string used in the art or made of any tangible material, such as nylon, gut, or steel. Stroboscopic light (not shown) may be used to make the strings vibrations apparent.

A resonance chamber 32, schematically shown in FIG. 2B may be coupled to string 31, by any suitable apparatus, in accordance with an embodiment of the invention, to amplify sounds generated by vibration of the string. The resonance chamber optionally resembles and/or has features of that of a violin. Resonance chamber 32 may be any resonance chamber used and/or known in the art and may be made of any material such as wood, metal. FIG. 2C schematically shows a top view of modular string apparatus after assembly.

In a first string instrument task, visitor 10 excites the string of the non-assembled modular string apparatus, shown in FIG. 2A, optionally by plucking it or by any other way such as by drawing a violin bow across it, causing the string to vibrate. Visitor 10 may excite the string with more force causing the string to vibrate with greater amplitude. Additionally, the visitor may pluck the string in multiple locations to generate more complex vibrational patterns. The visitor may observe the motion of vibrations of the string with an unaided eye or an image on a screen generated by a camera (not shown).

In a second string instrument task, visitor 10 couples string 31 to resonance chamber 32, as schematically shown in FIG. 2C, and then proceeds to excite the string. Sounds generated by plucking the strings are amplified by the resonance chamber and are now readily heard by the human ear, in addition to being seen as in the previous task. The visitor's may acquire a perception and understanding of the components generating sound.

In a third string instrument task, visitor 10 may couple a different resonance chamber (not shown) to the string of modular string apparatus 30, and perceive different sounds generated by the same string. The different resonance chamber may differ from resonance chamber 32 in its physical characteristics, such as size, shape and material composition. Optionally the different resonance chamber is a sound amplifier known and/or used in the art, and may resemble a body of a guitar. When the visitor plucks the string, he or she may perceive the influence of the physical characteristics of the different resonance chamber on the sound's timbre. Additional and different resonance chambers may be used in the third task so that visitor 10 may repeat the task, further perceiving different timbres generated when plucking the same string coupled to various resonance chambers.

In a fourth string instrument task, visitor 10 may replace string 31 with a different string (not shown) to learn and understand how physical characteristics of a different string influence the timbre generated by the different string. The visitor may repeat task one through three described above, using optionally a string used in the art or made of any other tangible material, having different physical characteristics (described above) than those of string 31. Optionally, additional and different strings are used, so that visitor 10 may combine various strings with various resonance chambers to further experience the different timbres generated when plucking the strings.

Optionally, modular string apparatus 30 comprises various strumming devices (not shown), such as a bow, pick, and or any other device, that may be used to excite the string. In an embodiment of the invention, in a fifth string instrument task, visitor 10 repeats tasks one through four described above, with different strumming devices to understand how the strumming devices affect the generation of sound.

Optionally more than one string may be coupled simultaneously to modular string apparatus, in accordance with an embodiment of the invention. When visitor 10 excites the strings simultaneously, he or she may appreciate the different sounds that are generated.

The sixth string instrument task, in accordance with an embodiment of the invention, involves familiarizing the visitor with known string instruments comprised in an additional display (not shown). The additional display may comprise various known string instruments, such as a violin, a guitar, a piano. The visitor may operate and excite known string instruments and perceive the various timbres generated responsive to the physical characteristics of components constructing the known string instruments.

After completing tasks related to string instruments, visitor 10 may approach and enjoy optionally an additional interactive exhibit having a musician or a human sized robot (not shown), playing a string instrument such as a guitar.

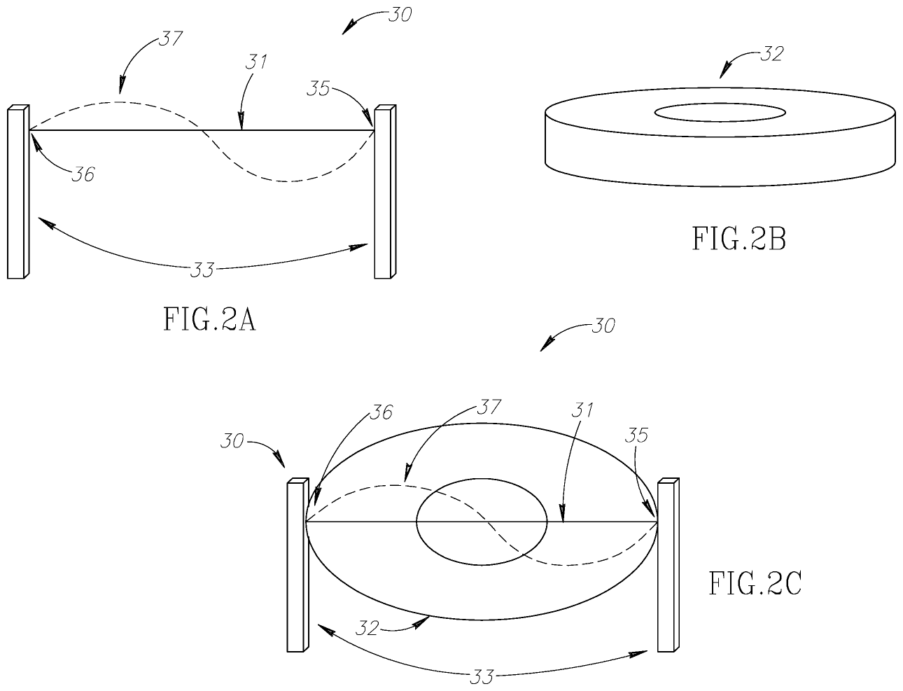

Once having completed tasks related to the string instruments, visitor 10 continues along the listening path in a direction R3 to a next sensualization space A2, where he or she experiences sounds generated by percussion instruments. The visitor operates an interactive percussion exhibit, referred to as a modular drum exhibit 40, schematically shown in FIG. 3A, FIG. 3C, in accordance with embodiments of the invention.

In an embodiment of the invention, modular drum exhibit 40 comprises a plurality of optionally six drumheads 42-47 and a plurality of optionally six drum shells 52-57, schematically shown in FIG. 3A and FIG. 3B, respectively. The drumheads may vary in physical characteristics, such as size, degree of tension applied to the drumhead, material, which may be animal skin or elastic. Optionally, drumheads may be any drumheads known and/or used in the art. The drumheads are schematically shown in FIG. 3A having different filling patterns, to distinguish the various drumheads. Similarly, drum shells 52-57, may differ from each other in their physical characteristics, such as size, radius of a shell's opening, material, which may be copper, fiberglass or aluminum. Optionally the drum shells are those known and/or used in the art.

As schematically shown in FIG. 3A, drumheads 42-47 are stretched on optionally circular rigid frames (not shown) which may be coupled to a post 41 by connector rods 48. Post 41 may be configured with optionally a support structure (not shown) such as legs or a wide base to support modular drum exhibit 40 when placed on a floor (not shown). Connector rods 48 may rotate about their axis, in a direction illustrated by curved double arrow 49, so that drumheads 42-47 can be positioned horizontally. FIG. 3C schematically shows modular drum exhibit 40 having optionally all the drumheads in a horizontal position, providing easier access to each drumhead.

Optionally and/or additionally, the connector rods may rotate about the post's axis so that the visitor may browse through the drumheads by turning them and pushing them against each other while allowing access to a given drumhead of choice, by spacing it apart from the others.

It is noted that various other drumheads may be added to modular drum exhibit 40 and/or replace drumheads 42-47, providing a changing display of drumheads. Similarly, additional drum shells (not shown) may be used to operate modular drum exhibit 40 or replace one or more of drum shells 52-57.

Optionally, additional modular drum exhibits may be comprised in sensualization space

A2 and may be operated by visitor 10, in series of tasks. Optionally, the additional modular drum exhibits may comprise other drumheads, having physical characteristics which are different from those of drumheads 42-47 comprised in modular drum exhibit 40.

FIG. 3C schematically shows drumhead 42 coupled with drum shell 52, forming a drum 62, in accordance with an embodiment of the invention. A clamping device (not shown) or any other device for coupling drum shell 52 to drumhead 42 may be used, which may support the weight of the drum shell. Additionally and/or alternatively, connector rod 48 may be lowered or elevated to bring drumhead 42 close to the drum shell, and to allow their coupling together while the drum shell is optionally placed on a floor (not shown) for support. Optionally connector rods 48 may be dismounted from the post so that a drumhead may be placed on a drum shell, forming a drum.

In an embodiment of the invention, drumhead 42 may be coupled to any other drum shell 53-57 to form another drum combination generating optionally a different timber and sound. Similarly and additionally, drumheads 43-47 may be coupled to drum shells 52-57 to form various combinations of drums. Whereas FIG. 3C is shown having only a single drum 62, embodiments of the invention aren't limited to having only one drum combined at a time, and additional drum combinations are possible providing modular drum exhibit 40 with a plurality of drums.

Whereas modular drum exhibit 40 is schematically shown and described to comprise six different drumheads and six different drum shells, embodiments of the invention, aren't limited to a modular drum exhibit comprising a particular number of drumheads and/or drum heads. Embodiments of the invention aren't limited to having drumheads and/or drum shells having physical characteristics which are different from those of another drumhead and/or drum shell, respectively.

By way of example, modular drum exhibit 40 may be configured with more than or less than six drumheads. Optionally, the drumheads may have characteristics which are similar to characteristics of another drumhead, such as having a same diameter, made of a similar material, configured with a similar tension. Similarly, any of the drum shells shown in FIG. 3B may have a characteristic similar to a characteristic in another drum shell, such as they may be made of a similar material, or have a same shell opening diameter.

In an embodiment of the invention, in a first percussion instrument task, visitor 10 may stimulate drumhead 42 by drumming on it, optionally with his or her hands, causing it to vibrate. The visitor rotates drumhead 24 to a horizontal position, as shown in FIG. 3C. The visitor may hear and/or see with an unaided eye the motion of vibration of the drumhead, or see an image of vibrating drumhead on a screen as captured by a camera (not shown). In addition the visitor may feel the vibration of the drumhead on his or her hand.

In a second percussion instrument task, visitor 10 may couple drumhead 42 to drum shell 52 forming drum 62 as schematically shown in FIG. 3C. The visitor may stimulate drum 62, by drumming on the drumhead again. In addition to seeing and feeling the vibrations of drumhead 42, sounds generated by drumming on drumhead 42 are readily heard by the human ear as drum shell 52 amplifies its vibration and sound characteristic to drum 62.

In a third percussion instrument task, visitor 10 may couple a different drum shell, such as drum shell 53, to drumhead 42, and perceive the different sounds generated by the same drumhead. The different drum shell may differ from the other drum shell in its physical characteristics (as described above). When the visitor drums on the drumhead, he or she may perceive the influence of the physical characteristics of drum shell 53 on a timbre generated. The visitor may replace drum shell 53 with other drum shells, such as drum shells 54-57, and further perceive the different timbres generated when drumming on the same drumhead, coupled to different drum shells.

In a fourth percussion instrument task, visitor 10 may form another drum, using drum shell 52 with any of the other drumheads of modular drum exhibit 40, such as drumhead 43, and repeat tasks one through three (described above), in accordance with an embodiment of the invention. The visitor may learn and understand how the physical characteristics of a different drumhead influence the timbre generated by drumming on the different drumhead. The visitor may repeat this task with the other drumheads, creating different drum combination with a same drum shell.

Optionally, modular drum exhibit 40 comprises various percussion mallets (not shown) such as drum sticks, wands, brushes, that are optionally known and/or used in the art. In a fifth percussion instrument task, visitor 10 may repeat tasks one through four (described above) with different percussion mallets to understand how the different mallets affect sound generation.

The sixth percussion instrument task, in accordance with an embodiment of the invention, involves familiarizing the visitor with known percussion instruments, comprised in an additional display (not shown). The additional display may comprise various known percussion instruments, such as Japanese taiko drums, tympani, and bass drums. The visitor may drum on any known percussion instruments and perceive the various timbres generated responsive to physical characteristics of the components constructing the known percussion instruments.

After having completed tasks related to percussion instruments, visitor 10 may approach and enjoy optionally an additional interactive exhibit having a musician or a human sized robot (not shown), playing a percussion instrument, such as taiko drums.

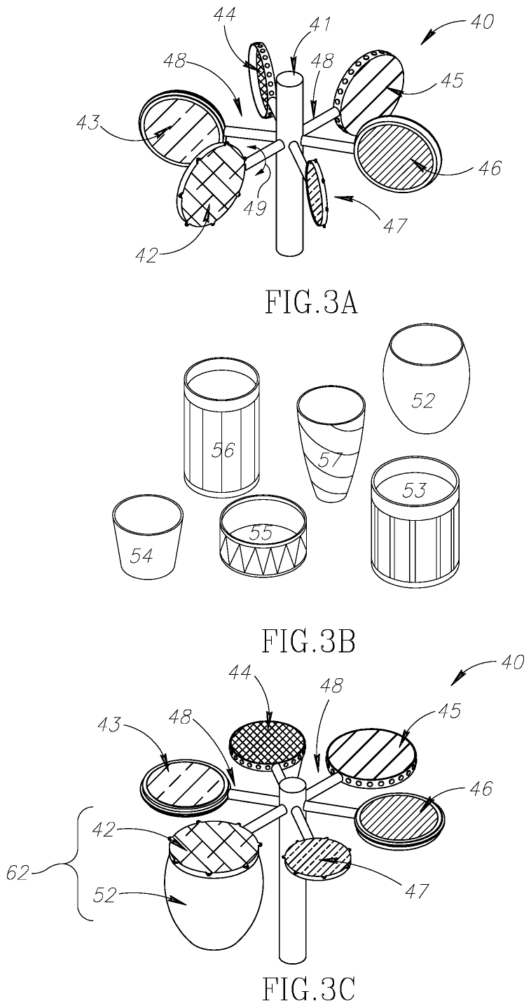

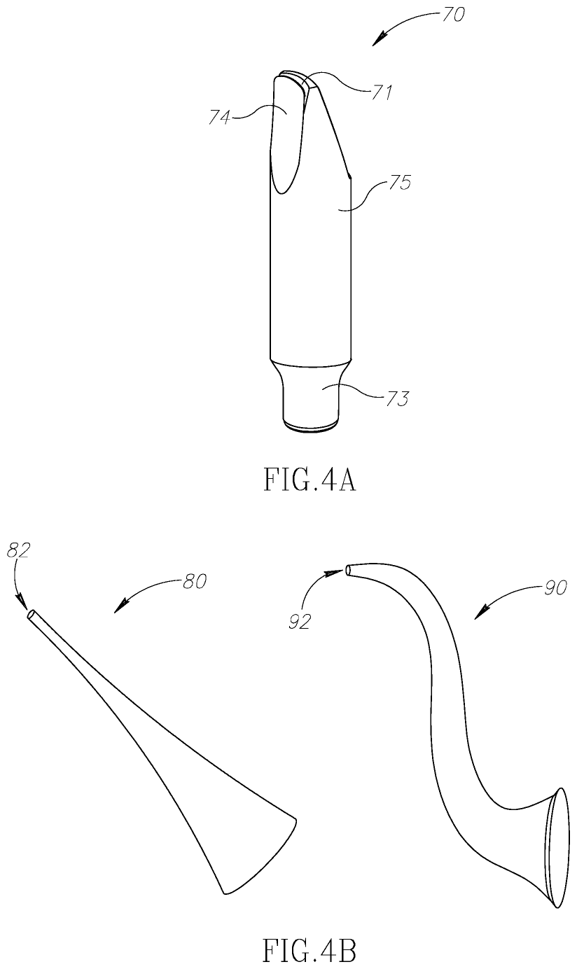

Having completed tasks related to percussion instruments, visitor 10 continues along the listening path in a direction R4 (FIG. 1), to sensualization space A3 components comprised in an interactive wind exhibit to experience sounds generated by wind instruments, in accordance with an embodiment of the invention. A mouthpiece 70 schematically shown in FIG. 4A and air tubes 80 and 90 schematically shown in FIG. 4B, in accordance with embodiments of the invention, are operated by the visitor in a series of tasks. The mouthpiece may resemble a saxophone mouthpiece, and optionally made of plastic. Mouthpiece 70 is configured with a tip opening 71, a body 75, and a shank 73 and optionally a reed 74.

Air tube 80 is configured with an optionally straight shape, and air tube 90 is configured with optionally a curved shape. The air tubes may be made of various materials used and/or known in the art, such as wood or brass. The air tubes are configured for coupling to mouthpiece 70 by matching and then optionally inserting the shank of mouthpiece 70 into opening 82 or 92 of air tubes 80 and 90, respectively. Optionally, additional air tubes (not shown) configured for coupling with mouthpiece 70 may be used. The additional air tubes may be configured with various shapes, sizes, lengths, optionally curved upon themselves having various types of bore shape and size, tip shapes and sizes, made of various materials such as wood or brass. Optionally the additional air tubes are air tubes known and/or used in the art.

In a first wind instrument task, visitor 10 may blow through the tip of mouthpiece 70 causing the reed and the air within the body of the mouthpiece to vibrate and generate a a buzzing noise. The visitor may physically sense the vibration in his or her mouth (not shown) and optionally in his or her chest (not shown). Optionally the visitor may see an image of the vibrating reed on a screen generated by a camera (not shown).

In a second wind instrument task, visitor 10 may couple mouthpiece 70 to air tube 80, and blow through the mouthpiece again. Sounds generated by blowing through the matching combination of mouthpiece 70 and the chosen air tube will now turn into a defined sound.

In a third wind instrument task, visitor 10 may couple air tube 90 to mouthpiece 70 and perceive the different sounds generated by it. Air tube 90 may have physical characteristics (as described above) which are different from those of air tube 80. When the visitor blows air through the tip of mouthpiece 70, he or she may perceive the influence of the physical characteristics of the air tube 90 on the timbre generated. Optionally, additional and different air tubes are used in the third task, so that visitor 10 may repeat the task, coupling a different air tube to the mouthpiece. The visitor may further perceive different timbres generated when blowing through tip of mouthpiece 70 when coupled to different air tubes.

In a fourth wind instrument task, visitor 10 may replace the mouthpiece with a different mouthpiece (not shown), to discover how physical characteristics, such as type of and material composition, and a size of a mouthpiece influence the timbre generated. Optionally mouthpieces used and/or known in the art may be used in series of tasks. Optionally mouthpieces having different sized body and tip opening are used in the fourth task. The visitor may repeat tasks one through three (described above), using optionally a relatively smaller mouthpiece and/or a relatively larger mouthpiece. The visitor may learn and understand how the different sized musical mouthpiece influences the pitch generated when blowing through its tip. For example, a relatively smaller musical mouthpiece generates a relatively higher pitched sound responsive to a relatively high frequency of vibration of air within the body of the mouthpiece, compared with a relatively larger musical mouthpiece generating a relatively low frequency of vibration of air.

The fifth wind instrument task (corresponding to task number six of the other instrument groups, described above), in accordance with an embodiment of the invention, involves familiarizing the visitor with known wind instruments comprised in an additional display (not shown). The additional display may comprise various known wind instruments, such as a flute, a saxophone, and a trombone. The visitor may blow air through them and perceive the various timbres generated responsive to the physical characteristics of components constructing the known wind instruments.

After completing tasks related to wind instruments, visitor 10 may approach and enjoy an optionally an additional interactive exhibit having a musician or a human sized robot (not shown), playing a wind instrument such as a saxophone.

In an embodiment of the invention, visitor 10 continues along the listening path in a direction R5 (FIG. 1) and optionally operates an electronic synthesizer (not shown) known in the art. The synthesizer is provided to allow the visitor to perceive a musical instrument without a self vibrating object as a source of sound generation. The synthesizer is configured to electronically generate a relatively wide range of different sounds by producing audio signals electronically generated by the synthesizer that may be converted, amplified and coupled to loudspeakers and/or headphones (not shown). Optionally the audio signals may be displayed in a time domain on an oscilloscope-style display. Optionally the audio signals may be displayed in a frequency domain on a spectrum-style display.

In a first synthesizer task, the visitor may interact with the synthesizer via analog controls or via a computer display in order to generate various simple sound signals. The visitor may see these signals in the time and/or frequency domains.

In a second synthesizer task, the visitor enables audio output and uses headphones or loudspeakers along with the time and/or frequency displays to readily hear the generated sounds. The visitor may change various characteristics of the generated sound, such as pitch, volume, duration, and repetition rate. Additionally, the visitor may see a vibration of the loudspeakers and/or headphones coupled to the synthesizer. Additionally, the visitor may concatenate sounds into simple compositions.

In a third synthesizer task, the visitor may select pre-recorded synthesis programs and repeat the previous tasks while varying various parameters such as pitch, timber of the digitally generated sounds. Additionally, the visitor may sample sounds by recording and then controlling the recorded sound sampled to alter its pitch and generate various tones and/or timbres. By sampling and synthesizing sounds, the visitor may perceive how a frequency changes a perception of sound, and pitch. For example, visitor 10 may record his or her own voice and alter the pitch of the voice by electronically changing the pitch frequency of the voice, and hear his or her own voice in a lower pitch corresponding to a lower fundamental frequency.

In an embodiment of the invention, multiple sensualization of sound region A may comprise additional interactive exhibits providing theoretical, readable material related to each group of musical instruments described above. Visitor 10 may approach the additional interactive exhibits once having completed the tasks of various groups of instruments and enrich his or her knowledge on subjects such as history and anatomy of musical instruments.

Whereas the first stage of the listening path is described above and schematically shown to comprise the series of tasks carried out in a particularly structured region of the visitor center, practice of the invention isn't limited to performing the series of tasks in a building or a visitor center or other establishment, as shown in FIG. 1. By way of example, the series of tasks may be carried out in a building structure different than that shown in FIG. 1, such as in a home, an educational or an amusement facility or other environment, optionally not having a particularly structured facility.

Once visitor 10 has completed the series of tasks described above in region A, the visitor continues to region B along the listening path in a direction indicated by a block arrow R6, as schematically shown in FIG. 1. In an embodiment of the invention, Region B comprises three spaces, labeled B1, B2 and B3 dedicated to different additional stages for interactively teaching and enhancing sound and music appreciation and the ability to listen and discern element of sound and music.

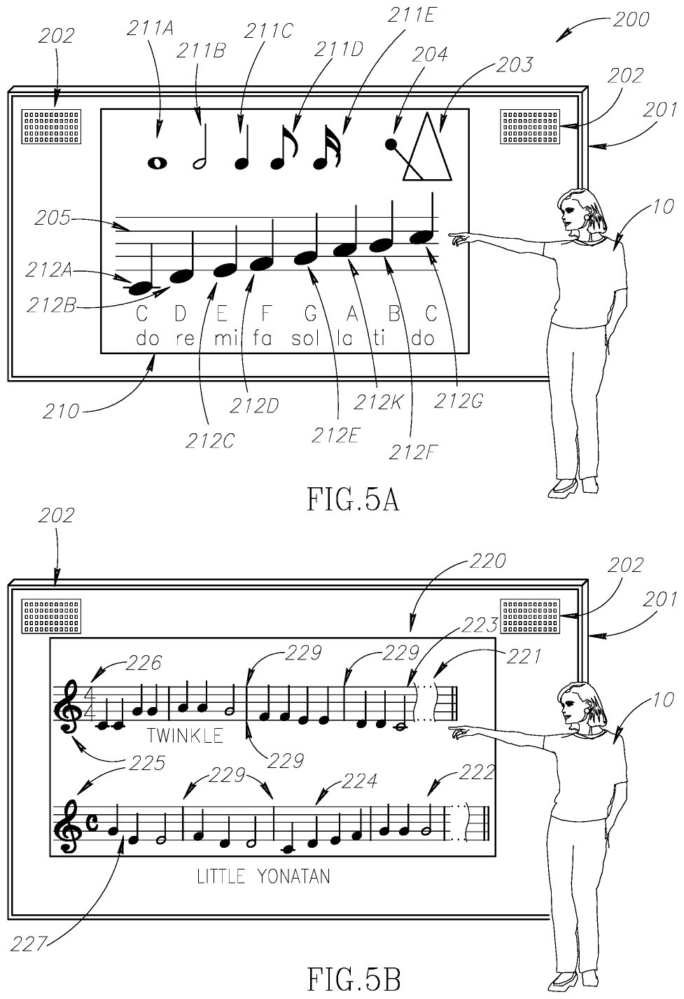

Space B1 comprises a Musical Wall 200 that provides visitor 10 an experience of the elements and components of optionally Western music. Musical Wall 200 comprises a large, optionally wall-sized touch screen 201, optionally a computer system (not shown), and speakers 202. The computer system is programmed to show a plurality of changing music displays, “music screens”, schematically shown in FIGS. 5A-FIG. 5D, in accordance with embodiments of the invention. The music screens are operated by the visitor in a sequential and ordered progression corresponding to the sequence of FIGS. 5A-FIG. 5D. The music screens are related so that each music screen expands upon concepts introduced in a previous music screen. Optionally, a plurality of musical walls is provided for use and operation by the visitor. Optionally each Musical Wall is programmed to show a particular music screen, so that the visitor progresses through music screens by progressing from one Music Wall to a next music wall.

Operation of music screen 210, as schematically shown in FIG. 5A, enables visitor 10 to correlate a music note with a sound. Music screen 210 is configured with optionally a virtual metronome 203 optionally having a pendulum 204, and musical touch notes, referred to as “note values”, optionally shaped as musical note values, so that each note value indicates its duration. Optionally, five note values are comprised in music screen 210, a whole note, half note, quarter note, eighth note, and sixteenth note, indicated by alphanumerics 211A-211E, respectively. When a note value is touched, it optionally lights up for a duration corresponding to a number of beats associated with a note value. Virtual metronome 203 indicates the number of beats and pendulum 204 swings back and forth, visualizing each beat.

Optionally, additional note values such as thirty-second note and/or other musical notational symbols are configured in screen 210, for operation by visitor 10.

Additionally, music screen 210 is configured with optionally eight music touch notes, optionally shaped as musical whole notes, referred to as “C notes”, alphanumerically indicated 212A-212H, and programmed to generate a pitch corresponding to a musical note of optionally a C major musical scale, in accordance with an embodiment of the invention. C notes 212A-212H are distributed across musical staff 205 and optionally beside each C note appears the C notes' Western letter pitch notes and/or syllables in solfege. By way of example, C note 212A corresponds to C (in Western letter pitch notation) or “do” (in solfege) as schematically shown in FIG. 5A. Similarly, C note 212B corresponds to D or “re”, C note 212C corresponds to E or “mi”, and so forth. When C note 212A is touched by visitor 10, it generates a C pitch, and optionally lights up when touched. Visitor 10 may visualize each C note's location on the staff and relate its pitch with its staff position.

Optionally, additional and various musical scales such as, other major scales, minor scale, diatonic scales, and chromatic scales, are configured for operation in music screen 210, in accordance with an embodiment of the invention. Visitor 10 may perceive different sequences and classes of pitches of music notes arranged in music scales.

In an embodiment of the invention, visitor 10 progresses to music screen 220, as schematically shown in FIG. 5B. Operation of music screen 220 enables the visitor to experience a sequence of music notes which generate a melody. Music screen 220 is configured with musical touch notes, shaped as musical notes and note values, optionally corresponding to music notes of a melody, “Twinkle” 221 and a melody of “Little Yonatan” 222, only parts of the melodies are shown in FIG. 5B. The music touch notes of each melody 221 and 222 are distributed on musical staffs 223 and 224, respectively, and divided into measures by bars 229, which divide each melody into groups of beats. The number of beats in each measure is indicated by time signatures 226 and 227, respectively (and discussed below). Each note plays a pitch related to a musical note and optionally lights up for a duration indicated by its note value, when operated.

By way of example, visitor 10 touches music touch notes of melody 221 in their order of appearance to play the melody Twinkle. When each touch note is operated it lights up and plays is associated musical note. Optionally, music touch notes of melody 221 are controlled by an additional touch button (not shown). When the visitor operates the additional touch button, the touch notes of melody Twinkle, light up in their order of appearance. The visitor may follow the progression in which a music touch notes light up and presses each note at its time to play the melody Twinkle. Visitor 10 may visualize the melody twinkle's sequence of notes and their presentation on the staff, their position in the melody, when playing the melody. Thereby, the visitor may acquire a perception of musical notes and music. Visitor 10 may operate melody 222 similarly to operation of melody 221.

Optionally, additional melodies having different levels of difficulty are provided in music screen 220.

FIG. 5B schematically shows additional musical notational symbols illustrated in melodies 221 and/or 222, such as a clef 225 indicating the pitch of the music notes on the staff, and time signatures 226 and 227 described above. Optionally, by pressing a musical notation such as clef 225, an audio explanation and/or a context box opens with a written explanation regarding the meaning of the musical symbols in music. The time signatures may be operated to generate a beating sound corresponding to four beats for each measure and optionally at a suitable tempo. The beating sound may accompany the melodies when operated, as described above, by simply touching the time signature to initiate the beating sound and once again to stop it. Optionally, an additional touch button (not shown) may be configured in music screen 220, so that when operated it may control the tempo in which the melody is played—fast, slow, moderate, to allow the visitor to experience how tempo changes the speed in which a melody is played. Similarly, a touch button may be configured to allow the visitor to transpose the “key” of the melodies, so that the music notes of a melody are played in a different pitch, allowing the visitor to perceive progression of the music notes in a different frequency.

After having completed operation of music screen 220, visitor 10 progresses to music screen 230, provided to enable him or her to experience complex compositions, such as counterpoint, canons, and chorales, in accordance with an embodiment of the invention. FIG. 5C schematically shows music screen 230 configured with optionally two sets of musical touch notes corresponding to a counterpoint by J.S. Bach and a cannon. The counterpoint comprises musical touch notes of melody 231 and melody 232, and a play key 235. The canon comprises musical touch notes of melody 238, imitation 239, and a play key 229.

Music notes of melodies 231 and 232 are each distributed across musical staves 233 and 234, and measures are confined between bars 236. Visitor 10 may operate each melody 231 and/or 232 independently and similarly to operation of melodies 221 and 222 in music screen 220. Visitor 10 may perceive the difference in sound, contour, rhythm and sequence of musical notes, of each independent melody. Visitor 10 may then operate play key 235, which controls musical touch notes of melodies 231 and 232, so that they are played simultaneously. As each note lights up at its turn the visitor may perceive how each note in melody 231 is played against one note of melody 232, composing the counterpoint. The visitor may learn to appreciate how both independent melodies played simultaneously sound harmonious. Additionally, as each music note lights up, visitor 10 may visually perceive staff position, and sequential position of each musical note, as it is played in the counterpoint.

Visitor 10 may then operate melody 238 and its imitation 239, similar to operation of melodies 231 and 232, described above. The visitor may operate play button 229, which controls the melody and the imitation so that they are played simultaneously. The imitation is played shortly after the melody is played generating a shift in time, to compose the canon. Additional imitations may be configured in the music screen and played simultaneously, each with a shift in time relative to a previous imitation in the canon, composing a richer cannon. In an embodiment of the invention, the additional imitations may vary from the original melody and/or from another imitation such as in time intervals, rhythms, and pitch.

Additional musical symbols such as a rest 237, indicating a silence equivalent to a half note, as indicated by its shape, and a sharp 228 indicating a higher pitch note, may be operated as clef 225 in music screen 220, described above.

Whereas FIG. 5C schematically shows music screen 230 configured with a “species counterpoint”, embodiments of the invention are not limited to a particular counterpoint. Various types of counterpoints having more complex melodic compositions, chorales comprising melodic vocals, and fugues, may be configured in music screen 230 or in additional music screens, in accordance with an embodiment of the invention.

The visitor may progress to music screen 240 schematically shown in FIG. 5D, once operation of music screen 230 has been completed. Music screen 240 is provided to enable the visitor to experience chords, music notes played simultaneously and that sound harmonious and accompaniment music. Music screen 240 comprises a plurality of optionally seven sets of three musical touch notes forming triad chords 241-247, chord names located underneath the chords respectively, and musical touch notes of a melody “Row, Row, Row Your Boat” 248. Chords 241-247 are optionally chords built upon C major scale degree. Chords 241-247 and melody 248 are distributed across musical staves 258 and 259, respectively. Each chord name controls all three music touch notes forming its chord, allowing all three notes of a chord to play simultaneously.

By way of example, chord 241 referred to as “C Major”, is comprised of three music touch notes, do, mi and sol. Visitor 10 may operate each music touch note of chord 241 individually, so that it may play its related musical note. Optionally the music touch notes light up when operated. Visitor 10 may then operate name chord C Major having all three touch notes play their associated music note simultaneously. The visitor may perceive the harmony of the three notes, and visualize their staff position as they light up. Optionally, additional chords corresponding to other musical scales and having less or more than three musical notes, such as seventh chords constructed of four notes, extended chords, minor and major chords, are configured in music screen 240.

Visitor 10 may then operate melody 248, only part of which is shown in FIG. 5D, similar to operation of melodies 221 and 222 of music screen 220, and perceive the musical notes staff position and pitch.

After the visitor has completed operation of the chords, the visitor may proceed to melody “Row, Row, Row, Your Boat” 248, which comprises music touch notes distributed across staff 259, and acquire an understanding of accompaniment music. Visitor 10 may operate melody 248, similar to operation of melodies 221 and 222, in music screen 220. Chord blanks 251-254 located underneath melody 248 are distributed across musical staff 255. Both melody 248 and chord blanks are joined by a brace 257, indicating that both music notes distributed across each staff are played at once. The chord blanks allow visitor 10 to understand the role of accompaniment music, by determining which chord is a suitable chord to accompany melody “Row Row Row Your Boat”. The visitor may choose from chords 241-247 by dragging and dropping a chord in a chord blank, and composing accompaniment music. After the visitor has determined which chord is suitable, he or she may operate play button 263, which controls both the melody and the accompaniment music composed by the visitor, so that they are played simultaneously. Optionally the visitor may operate the play key to play the melody and accompaniment music, despite if the accompaniment music is completed or not. The visitor will hear if the chords chosen are suitable and in harmony with the melody, and may change a chosen chord to correct his or her original choice.

Additional notation, such as treble clef 261 and bass clef 262 respectively, are illustrated on the staves and may be operated as clef 225 described above in relation to music screen 220.

Whereas the music screens described above are configured with musical notation and musical touch notes corresponding to Western music system, embodiments of the invention aren't limited to teaching and/or learning music appreciation of the Western music only. By way of example, music screens may also comprise musical touch notes of non-Western music such as the Indian “svar lippi” system. Additionally, musical staffs and other musical symbols may suggest those suitable from piano notation, however, other musical instrument notations may be easily introduced in the music screen, such as guitar notation, in accordance with an embodiment of the invention.

Whereas the music wall above is described and shown in the figures to comprise a touch screen, embodiments of the invention aren't limited to a music wall comprising a touch screen, and a music wall comprising a musical keyboard comprising keys and buttons corresponding to musical notes and musical symbols, may be used.

Once the visitor has completed operation of music wall 200, and its related music screens described above, he or she may continue along to a next stage of the listening path, in a direction indicated by a block arrow R7 and enter space B2, in accordance with an embodiment of the invention. Space B2 comprises an Audio Mixing Station 280, provided to allow the visitor to explore and be exposed to various musical compositions of various musical genres.

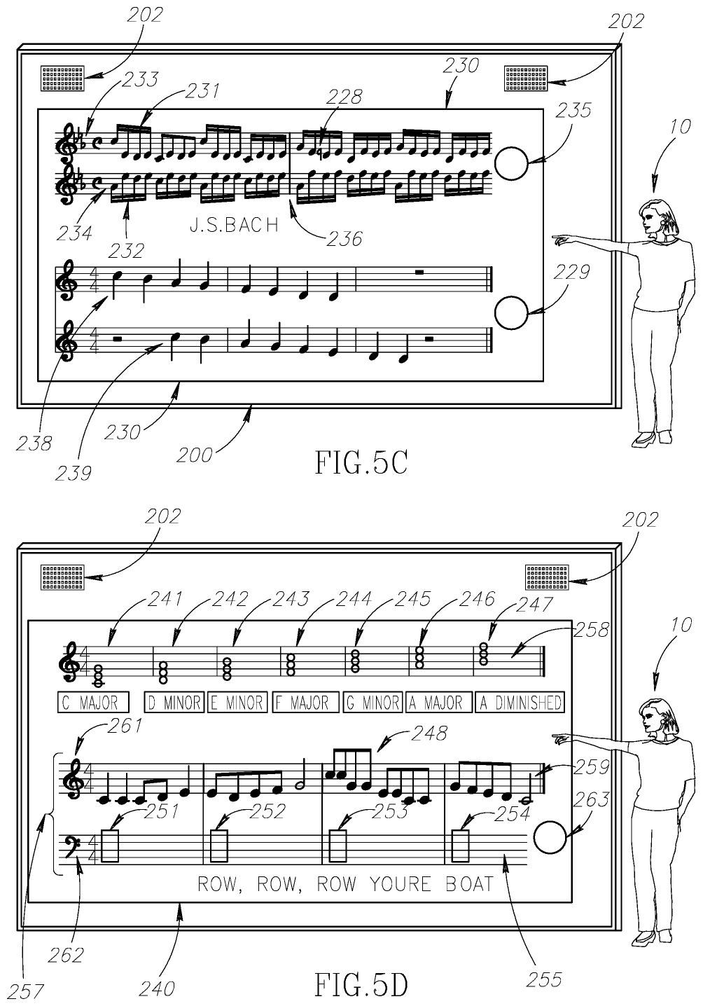

FIG. 6 schematically shows an Audio Mixing Station 280 comprising a mixing station screen 281, optionally a touch screen, configured with a vocal touch button 282, a string touch button 283, a percussion touch button 284, a wind touch button 285, a musical genre touch button 286, and optionally headphones in accordance with an embodiment of the invention. The visitor may choose musical genres from music genre touch button 286 which opens a list of genres in a context box 289 such as Pop, Jazz, Classic, and Rock′n Roll. The visitor may choose a genre by pressing the name of the genre as it appears in the context box. After choosing a genre, an additional list opens (not shown) listing various musical compositions, songs and/or other musical pieces pertaining to that genre, from which the visitor chooses a musical composition. After choosing a musical composition, the visitor may operate the various touch buttons by touch and drag the buttons in order to audio-mix the different musical instruments playing the musical composition, and optionally to listen to each type of instrument separately.

By way of example, visitor 10 puts on headphones 287 to prevent outside interference from other visitors operating other interactive exhibits, when audio-mixing the musical composition with touch buttons of mixing station screen 281. Optionally, when choosing the musical composition, visitor 10 may operate it to play its full length, by simply pressing the name of the composition. While the musical composition of choice is being played, visitor 10 may touch and drag vocal touch button 282 in direction indicated by double arrow head 290, to raise the volume of the vocals in the musical composition, as illustrated by dashed lines, or silence it by touch and drag the vocal touch button in the other direction. Similarly, visitor 10 may operate string touch button 283, percussion touch button 284 and/or wind touch button 285 to raise or lower the volume of string instruments, percussion instruments, and wind instruments, respectively. The visitor listens to the different types of musical instruments playing the musical composition, and may appreciate a contribution of a musical instrument to the musical composition. The visitor may appreciate the harmony of all musical instruments playing at once, after listening to each group of instruments separately.

Optionally additional or other touch buttons are configured in mixing station screen 281, corresponding to particular musical instruments of a musical compositions, such as guitar, drums, trumpet, saxophone, and vocals, so that the visitor may control a particular musical instruments when audio-mixing.

Optionally, touch button are configured having three positions of loudness, mute/quiet, medium volume and loud.

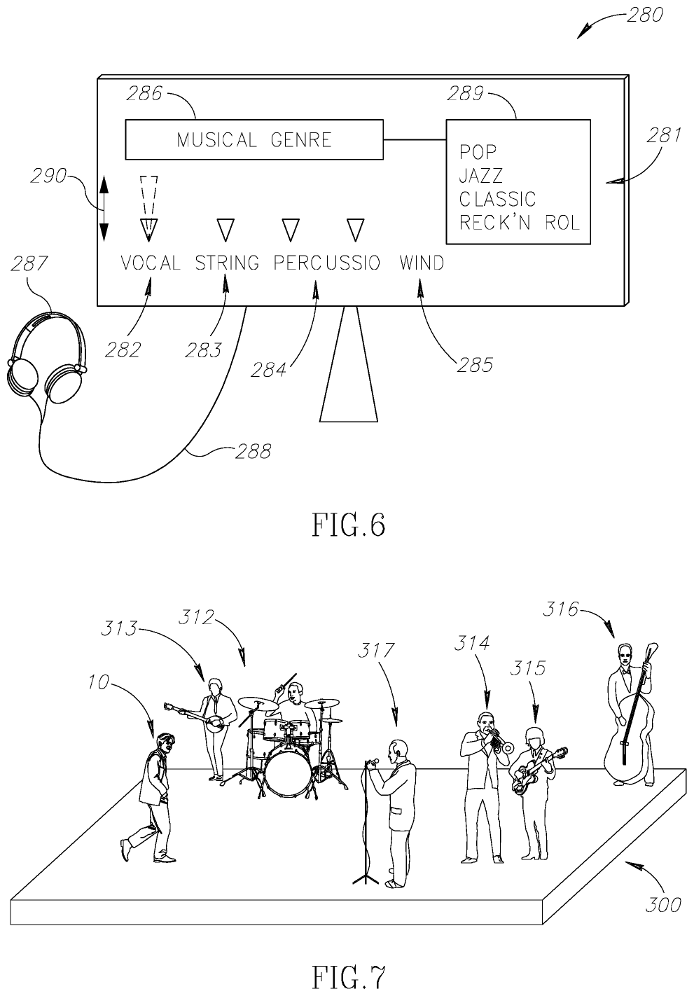

In an embodiment of the invention, and after having experienced audio-mixing, visitor 10 continues to optionally a last stage along the listening path, in a direction indicated by block arrow R8 and enters space B3 comprising a Live Stage 300. FIG. 7 schematically shows the Live Stage 300 having optionally a jazz band comprising optionally six musicians playing various musical instruments such as drums 312, a banjo 313, a trumpet 314, a guitar 315, a double bass 316, and a singer 317, in accordance with an embodiment of the invention. The Live Stage imitates optionally a Live Stage during a performance The visitor walking on the Live Stage between the musicians as they are playing the various instruments, may listen, see and optionally feel the vibrations generated by the various musical instruments, hear the different sounds generated by the different musical instrument coming from different directions, relative to his or her location on the stage, and experience the music played with a relatively greater appreciation and understanding. Live Stage 300 comprises optionally loud speakers and other settings, such as seats in front of the stage (not shown) to enhance a sensation of a live performance as the visitor is experiencing the music played by the Jazz band, on the stage.

Optionally more or less musicians and/or singers may be on Live Stage 300. Optionally, the Live Stage may comprise other types of musical bands, such as an orchestra, a rock band, and a concert band.

In an embodiment of the invention, and after visitor 10 has experienced the Live Stage, he or she completed the listening path. The visitor may exit space B3 and freely explore the rest of the regions configured in the visitor center. Optionally the visitor exits space B3 in a direction indicated by a block arrow R9, as schematically shown in FIG. 1. Visitor 10 may then enter “music mirroring culture and religion” region C, in accordance with an embodiment of the invention. Region C comprises various interactive exhibits (not shown) providing the visitor with sound and music experiences related to cultures, religions, ethnic origins, such as the influences of a religion or culture on music.

In an embodiment of the invention, FIG. 1 schematically shows region C configured with optionally a circular interactive exhibit 400, referred to as “the concert of three religions exhibit”. The concert of three religions exhibit is configured with optionally three mobile walls 401, 402 and 403 indicated by dashed lines and dividing the display into three unsealed religious spaces C1, C2, C3. Each religious space relates to a different religion or culture. Visitor 10 may move from one religious space to the next one freely. In an embodiment of the invention, each of the religious spaces comprises a ceiling video screen (not shown) or any other device for displaying content such as a slide projector. Optionally, the ceiling video screen is located on a ceiling (not shown) of a religious space. The ceiling video screen may show and present various contents related to a religious and/or cultural theme associated with a religious space such as, prayers, verses and passages from prayers, religious figures and images. Optionally the content presented on a ceiling video screen of a religious space has a similar meaning and/or concept to content presented on video screens of the other religious space, showing a similarity of traits and/or characteristics between the religions of each religious space. Additionally, each of the religious spaces comprises an audio system (not shown) playing traditional music and/or cultural music related to the religious and/or cultural theme of the religious space.

By way of example, themes for religious spaces C1, C2 and C3 may be Christianity, Islam, and Judaism, respectively. Video screen of religious space C1 may present content related to Christianity, such as verses from the New Testament. Music played in religious space C1 may be church music and/or music played by a pipe organ, which is identified with Gospel or other church music. The Muslim content displayed on the video screen of religious space C2 may comprise verses from the Quran. Music played in religious space C2 may be various types of Muslim devotional music such as Nasheed and Sufi, the muezzin and/or music played on an oud or darbuka. Similarly, Judaic content displayed on the video screen of religious space C3 may comprise various verses from the Old Testament. Music and/or songs played in religious space C3 may be Piyyutim and Zemiros and/or music played by a violin or a harp. Optionally, music played in each religious space may be heard in another space at the same time.

When the mobile walls are lowered down the ceiling video screens of all the religious spaces, appear as a united, continuous large video display, and music played in each of the religious spaces is combined sound harmonious. The visitors who are present in any of the three religious spaces of the concert of three religions exhibit are immersed in an intense experience as the religious spaces are united to a larger space, and the distinct music played in each of the religious spaces is blended to form a harmonious concert—the concert of three religions. The contents displayed on the ceiling video screens are simultaneously presented optionally without a particular order so that all religious visual content is combined and displayed optionally simultaneously.

In an embodiment of the invention, and after having experienced the concert of three religions exhibit 400, visitor 10 may continue in a direction indicated by a block arrow R10 to a “music and other art forms” region D, comprising various interactive music and other art form exhibits provided to enhance the visitors ability to perceive the role of music and sound in an art work combining other art forms, and to reflect the role of music and sound, its contribution to, and its significance in various art works belonging to other types of art forms such as dance, theatre, cinema, television and radio.

The visitor may continue in a direction indicated by a block arrow R11, upon exiting region

D, to optionally enter an “interactive amusement exhibits space” region E, schematically shown in FIG. 1, in accordance with an embodiment of the invention. Region E may comprise various interactive exhibits provided to amuse the visitor for his or her enjoyment and make him or her explore the miraculous dimension of listening to sound and music. The interactive exhibits entertain the visitor and display sound and music concepts and elements presented and introduced in other interactive exhibits comprised in the other regions of the visitor center.

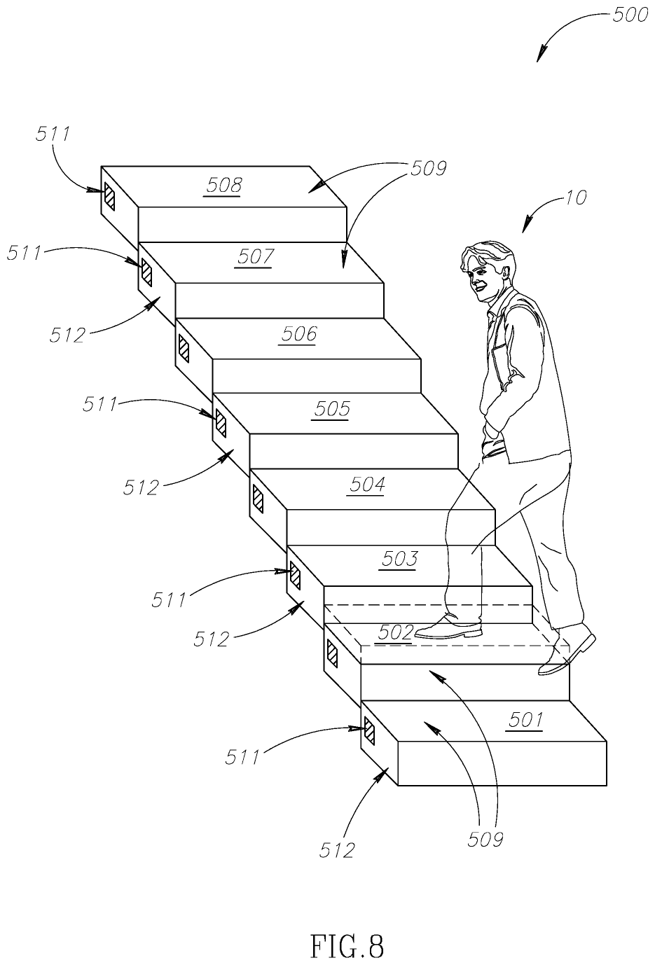

By way of example, a musical entertainment exhibit in region E may comprise a set of musical stairs 500 schematically shown in FIG. 8. A visitor generates musical sounds by climbing up the stairs. Musical stairs 500 comprise optionally eight mobile stairs 501-508, speakers 511 located on optionally the sides 512 of each stair (in the figure only one of which is shown for each stair), weight sensors (not shown), lighting devices (not shown) and a computer system (not shown). A weight sensor and a lighting device are coupled to optionally a top surface 509 of each stair. The top surface of each of stair 501-508 may be made of any clear or transparent material known and/or used in the art, such as glass or Plexiglas, so that when a lighting device is operated, a stair's top surface lights up. Optionally, all sides of each of the stairs of musical stairs 500 are made of a clear and/or transparent material. The computer system is programmed to generate sounds corresponding to pitches of musical notes of optionally a C major musical scale. Each stair is related to a particular pitch. For example, stair 501 may be associated with a tone of do, stair 502 to re, 503 to mi, stair 504 to fa, stair 505 to sol, stair 506 to la, stair 507 to si, and stair 508 to a do of a next higher octave. The computer system controls the generation of tones responsive to signals received from the weight sensors of each stair 501-508 (as described below). The weight sensors sense a weight of a visitor when climbing a stair, so that it sends a signal to the computer, and the computer, in return triggers the production of an appropriate tone. In addition, the computer system controls the operation of a lighting device in each stair and mobility of the mobile stairs, in accordance with an embodiment of the invention.

By way of example, visitor 10 begins climbing up musical stairs 500, as schematically shown in FIG. 8. When his or her body weight is sensed by weight sensor (not shown) of stair 502, a signal is received by the computer system. The computer system responds to the signal by triggering the mobility of stair 502 to sink optionally by approximately half its height. Dashed lines of stair 502 in FIG. 8 illustrate stair's 502 rest position, before sinking in a direction indicated by double arrow 513. Additionally, the computer system controls the lighting device (not shown) of stair 502 to light up and illuminate top surface 509 lights up. As the stair sinks and lights up, the computer system produces a tone on speaker 511 of the musical tone related to stair 502. When visitor 10 leaves stair 502, the weight sensor senses the absence of weight, transmits a signal indicating the absence of weight to the computer system. The computer system in turn, turns off the lighting device, stops production of sound, and controls the movement of the stair upwards as indicated by the double arrowhead 513, to its rest position. Visitor 10 may climb up all the stairs, to hear the C major musical scale, while each stair lights up and sinks in its turn.

Whereas musical stairs 500 described above comprises weight sensors, embodiments of the invention aren't limited to operation of musical stairs in response to information received from the weight sensors. Musical stairs 500 may comprise pressure sensors and/or presence sensor and/or cameras, detecting the presence of a visitor on a stair providing the information to the computer system for controlling the operation of the musical stairs.

It is noted that computer system may be responsive to a weight threshold value, so that the computer responds to the weight values that exceed the weight threshold value.

In an embodiment of the invention, each stair may be divided into more than one section, to enable each section to generate an independent sound, so optionally more than one person can stand simultaneously on the same stair to generate a number of sounds as the number of sections. Optionally visitor 10 climbs musical stairs by stepping on one section of each stair, descending on another. Optionally more than one visitor may climb up the stairs simultaneously, so that more than one sound may be simultaneously generated.

Lighting devices coupled to the stairs may be configured to emit light in different colors.

In an embodiment of the invention, visitor 10 may enter a “musical garden” region F, optionally, an outdoor garden, comprising various interactive exhibits combining sound and musical elements and concepts with elements and concepts of a garden. The musical garden is optionally provided as a resting space while the interactive exhibits which are comprised in the garden are provided optionally to amuse the visitor and/or to enhance awareness and curiosity to sound and music and the visitor's ability to listen to the sounds and music.

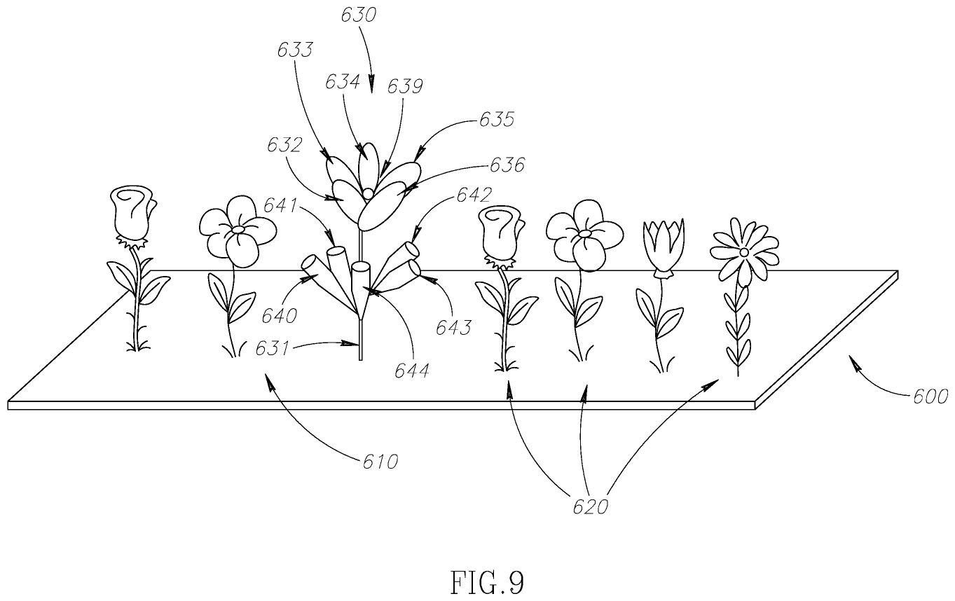

In an embodiment of the invention, musical garden comprises a musical flower garden 600 comprising a combination of real flowers and musical flowers as schematically shown in FIG. 9. Musical flower garden 600 comprises a flower bed 610 provided for planting various real flowers 620, and a musical flower 630. The musical flower comprises a stalk 631, a plurality of optionally five petals 632-636 coupled to an end (not shown) of the stalk, a central ball 639, and a plurality of optionally five leaves 640-644 coupled to, and along the stalk. The leaves may be hollow and/or partially hollow cylindrical tubes. The petals and leaves 640-644 are composed of any suitable material such as metal, wood, or glass. Features such as length, thickness, and density of material, from which the petals and/or leaves are made are configured so that when a visitor shakes and/or touches the petals and/or the leaves, they may each vibrate, each at a different frequency, producing a sound different from the other petals and/or leaves. Additionally, the petals may strike each other and/or the central ball, generating various sounds Similarly, the leaves may strike each other, generating various sounds. Additionally, flower garden 600 may comprise a plurality of musical flowers and/or real flowers, and they may strike each other, when moved or shaken by wind or touch, causing the musical flowers and their petals and leaves to vibrate, producing the various sounds.

Whereas musical flower 630 described above is shown to comprise five petals and five leaves, embodiment of the invention are not limited to a particular number of petals and/or leaves. Similarly, embodiments of the invention aren't limited to leaves and/or petals having a particular shape, and the leaves and petals may have other shapes than those described and shown in FIG. 9 and may have shapes which are different from one another. By way of examples, the leaves may have a linear shape or elliptic shape or shaped as bells or have a combination of leave shapes.

It is noted that musical flower bed may comprise a plurality of musical flowers, optionally having each made of different materials, configured to generated different sounds, in accordance with an embodiment of the invention.

In another embodiment of the invention, a computer (not shown) may be comprised in flower bed 600, controlling the musical flowers petals and leaves to generate any sound desired, when the petals and/or leaves are operated. By way of example, sensors, sensing the movement of the leaves and/or petals may be comprised in musical flower, providing information to the computer which in turn generates sounds for each vibrating leave and/or petal.

It is noted that the musical flower as described above and shown in the figures, may be used and embedded in a garden and or flower bed among plantation and flowers, for use and amusement, and may be provided in a kit for easy packaging.

Whereas the visitor was strictly guided through the listening path in regions A and B to perform tasks and operate the interactive exhibits in a particular order of progression, exploring regions C, D, E and F may not have any particular order and the visitor is free to progress between regions C, D, E, and F and between interactive exhibits comprised in regions C, D, E and F in any order according to the visitor's choice and desire. For example, the visitor may exit region C to enter region F by going in a direction indicated by a double head block arrow R14, the musical garden, and/or explore regions D or E by moving in directions indicated by double head block arrows R10 and R12. At any of the regions C, D and E the visitor may exit in a direction indicated by arrows R14, R13, R12, respectively and enter the musical garden, or enter any of regions C, D and E and explore the interactive exhibits comprised in each of the regions.

In embodiment of the invention, interactive exhibits described above and shown in the figures may be configured in shape and size to allow operation by children. By way of example, modular drum exhibit 40 may be downsized for the use and operation of a child, and for easy packaging. Optionally interactive exhibits may be configured as a table top or a kit and/or toys.

It is noted that the interactive exhibits described above, such as the musical wall and/or Audio Mixing Station may be configured as applications for use in a mobile communication device, such as on a smartphone, iPad, and the like.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A music visitor center comprising:
an interactive string instrument exhibition comprising at least one resonance chamber and at least one string that may be mounted to the at least one resonance chamber and excited to vibrate and generate an amplified musical sound;
an interactive percussion instrument exhibition comprising at least one drum shell and at least one drumhead that may be mounted to the at least one drum shell and excited to vibrate and generate an amplified percussive sound;
an interactive wind instrument exhibition comprising at least one air tube and at least one mouthpiece having a reed that may be mounted to the at least one air tube and excited to vibrate and generate an amplified wind instrument sound; and
a path along which the exhibitions are located that constrains a visitor moving along the path to encounter in order, the string, percussion and wind instrument exhibitions.

2. A music visitor center according to claim 1 wherein the string instrument exhibition comprises a robot playing a string instrument.

3. A music visitor center according to claim 1 wherein the percussion instrument exhibition comprises a robot playing a percussion instrument.

4. A music visitor center according to claim 1 wherein the wind instrument exhibition comprises a robot playing a wind instrument.

5. A music visitor center according to claim 1 and comprising a synthesizer positioned along the path that is encountered subsequent to encountering the wind instrument exhibition that may be operated to mimic at least one or more of musical instruments chosen from the group of instruments consisting of a string instrument, a percussion instrument and a wind instrument.

6. A music visitor center according to claim 1 and comprising an interactive music apparatus comprising:
a touch screen; and
a controller that generates a display on the touch screen comprising a sequence of musical notes that may be played by touching the notes to sound a musical composition.

7. An interactive music apparatus according to claim 6 wherein the controller displays the musical notes on a musical staff.

8. An interactive music apparatus according to claim 6 wherein the controller sequentially illuminates the notes in an order in which they are sounded in the musical composition to prompt a user to touch the notes in a sequence that plays the musical composition

9. An interactive music apparatus according to claim 6 wherein the controller illuminates each note for a period of time proportional to its note value in the composition

10. A musical garden comprising:
a flower bed; and
a plurality of artificial plants in the flower bed each plant comprising a leaf and/or petal that may be excited by being touched to generate a musical sound.

11. A method of enhancing a person's musical appreciation comprising:
interacting the person with an interactive string instrument exhibition comprising at least one resonance chamber and at least one string that the person may mount to the at least one resonance chamber and excite to vibrate and generate an amplified musical sound;
subsequently interacting the person with an interactive percussion instrument exhibition comprising at least one drum shell and at least one drumhead that the person may mount to the at least one drum shell and excite to vibrate and generate an amplified percussive sound; and
thereafter interacting the person with an interactive wind instrument exhibition comprising at least one air tube and at least one mouthpiece having a reed that the person may mount to the at least one air tube and excite to vibrate and generate an amplified wind instrument sound.
a path along which the exhibitions are located that constrains a visitor moving along the path to encounter in order, the string, percussion and wind instrument exhibitions.
